(19) United States
(12) Patent Application Publication
(10) Pub. No.: US 2004/0057521 A1
(43) Pub. Date: Mar. 25, 2004

(54) Method and apparatus for transcoding between hybrid video CODEC bitstreams

(75) Inventors: Stephen F. Brown, West Ryde (AU); Marwan A. Jabri, Broadway (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Macchina Pty Ltd., Broadway (AU)

(21) Appl. No.: 10/620,329

(22) Filed: Jul. 14, 2003

Related U.S. Application Data
(60) Provisional application No. 60/431,054, filed on Dec. 4, 2002.
(60) Provisional application No. 60/417,831, filed on Oct. 10, 2002.
(60) Provisional application No. 60/396,891, filed on Jul. 17, 2002.
(60) Provisional application No. 60/396,689, filed on Jul. 17, 2002.

(51) Int. Cl. H04N 7/12

(52) U.S. Cl. 375/240.25; 375/240.26; 375/240.08

(57) ABSTRACT

A method and apparatus for performing transcoding between bitstreams coded by hybrid video codecs which uses fewer resources than decoding/decompressing the original bitstream and recoding/recompressing it to the second format. According to a specific embodiment, the present method can exploits the similarity of the standard video compression algorithms to, where possible, convert encoded parameters in the incoming bitstreams directly into encoded parameters which constitute compliant data for the outgoing bitstream.

### CROSS-REFERENCES TO RELATED APPLICATIONS

This application claims priority to U.S. Provisional No. 60/396891, filed Jul. 17, 2002; No. 60/396689, Jul. 17, 2002; No. 60/417831, Oct. 10, 2002; No. 60/431054, Dec. 4, 2002, which are incorporated by reference herein.

### STATEMENT AS TO RIGHTS TO INVENTIONS MADE UNDER FEDERALLY SPONSORED RESEARCH OR DEVELOPMENT

NOT APPLICABLE

### BACKGROUND OF THE INVENTION

The present invention relates generally to telecommunication techniques. More particularly, the invention provides a method and system for transcoding between hybrid video CODEC bitstreams. Merely by way of example, the invention has been applied to a telecommunication network environment, but it would be recognized that the invention has a much broader range of applicability.

As time progresses, telecommunication techniques have also improved. There are now several standards for coding audio and video signals across a communications link. These standards allow terminals to interoperate with other terminals that support the same sets of standards. Terminals that do not support a common standard can only interoperate if an additional device, a transcoder, is inserted between the devices. The transcoder translates the coded signal from one standard to another.

I frames are coded as still images and can be decoded in isolation from other frames.

P frames are coded as differences from the preceding I or P frame or frames to exploit similarities in the frames.

Some hybrid video codec standards such as the MPEG-4 video codec also supports “Not Coded” frames which contain no coded data after the frame header. Details of certain examples of standards are provided in more detail below.

Certain standards such as the H.261, H.263, H.264 and MPEG-4-video codecs both decompose source video frames into 16 by 16 picture element (pixel) macroblocks. The H.261, H.263 and MPEG-4-video codecs further subdivide each macroblock is further divided into six 8 by 8 pixel blocks. Four of the blocks correspond to the 16 by 16 pixel luminance values for the macroblock and the remaining two blocks to the sub-sampled chrominance components of the macroblock. The H.264 video codec subdivides each macroblock into twenty four 4 by 4 pixel blocks, 16 for luminance and 8 for sub-sampled chrominance.

Hybrid video codecs generally all convert source macroblocks into encoded macroblocks using similar techniques. Each block is encoded by first taking a spatial transform then quantizing the transform coefficients. We will refer to this as transform encoding. The H.261, H.263 and MPEG-4-video codecs use the discrete cosine transform (DCT) at this stage. The H.264 video codec uses an integer transform.

The non-zero quantised transform coefficients are further encoded using run length and variable length coding. This second stage will be referred to as VLC (Variable Length Coding) encoding. The reverse processes will be referred to as VLC decoding and transform decoding respectively. Macroblocks can be coded in three ways;

“Intra coded” macroblocks have the pixel values copied directly from the source frame being coded.

“Inter coded” macroblocks have pixel values that are formed from the difference between pixel values in the current source frame and the pixel values in the reference frame. The values for the reference frame are derived by decoding the encoded data for a previously encoded frame. The area of the reference frame used when computing the difference is controlled by a motion vector or vectors that specify the displacement between the macroblock in the current frame and its best match in the reference frame. The motion vector(s) is transmitted along with the quantised coefficients for inter frames. If the difference in pixel values is sufficiently small, only the motion vectors need to be transmitted.

Generally all the hybrid video codecs often have differences in the form of motion vectors they allow such as, the number of motion vectors per macroblock, the resolution of the vectors, the range of the vectors and whether the vectors are allowed to point outside the reference frame. The process of estimating motion vectors is termed “motion estimation”. It is one of the most computationally intensive parts of a hybrid video encoder.

“Not coded” macroblocks are macroblocks that have not changed significantly from the previous frame and no motion or coefficient data is transmitted for these macroblocks.

The types of macroblocks contained in a given frame depend on the frame type. For the frame types of interest to this algorithm, the allowed macroblock types are as follows;

I frames can contain only Intra coded macroblocks.

P frames can contain Intra, Inter and “Not coded” macroblocks.

Prior to transmitting the encoded data for the macroblocks, the data are further compressed using lossless variable length coding (VLC encoding).

Another area where hybrid video codecs differ is in their support for video frame sizes. MPEG-4 and H.264 support arbitrary frame sizes, with the restriction that the width and height as multiples of 16, whereas H.261 and baseline H.263 only supports limited set of frame sizes. Depending upon the type of hybrid video codecs, there can also be other limitations.

A conventional approach to transcoding is known as tandem transcoding. A tandem transcoder will often fully decode the incoming coded signal to produce the data in a raw (uncompressed) format then re-encode the raw data according to the desired target standard to produce the compressed signal. Although simple, a tandem video transcoder is considered a “brute-force” approach and consumes significant amount of computing resources. Another alternative to tandem transcoding includes the use of information in the motion vectors in the input bitstream to estimate the motion vectors for the output bitstream. Such alternative approach also has limitations and is also considered a brute force technique.

From the above, it is desirable to have improved ways of converting between different telecommunication formats in an efficient and cost effective manner.

### BRIEF SUMMARY OF THE INVENTION

According to the present invention, techniques for telecommunication are provided. More particularly, the invention provides a method and system for transcoding between hybrid video CODEC bitstreams. Merely by way of example, the invention has been applied to a telecommunication network environment, but it would be recognized that the invention has a much broader range of applicability.

A hybrid codec is a compression scheme that makes use of two approaches to data compression: Source coding and Channel coding. Source coding is data specific and exploits the nature of the data. In the case of video, source coding refers to techniques such as transformation (e.g. Discrete Cosine Transform or Wavelet transform) which extracts the basic components of the pixels according to the transformation rule. The resulting transformation coefficients are typically quantized to reduce data bandwidth (this is a lossy part of the compression). Channel coding on the other hand is source independent in that it uses the statistical property of the data regardless of the data means. Channel coding examples are statistical coding schemes such as Huffman and Arithmetic Coding. Video coding typically uses Huffinan coding which replaces the data to be transmitted by symbols (e.g. strings of ‘0’ and ‘1’) based on the statistical occurrence of the data. More frequent data are represented by shorter strings, hence reducing the amount of bits to be used to represent the overall bitstream.

Another example of channel coding is run-length encoding which exploits the repetition of data elements in a stream. So instead of transmitting N consecutive data elements, the element and its repeat count are transmitted. This idea is exploited in video coding in that the DCT coefficients in the transformed matrix are scanned in a zigzag way after their quantization. This means that higher frequency components which are located at the lower right part of the transformed matrix are typically zero (following the quantization) and when scanned in a zigzag way from top left to bottom right of matrix, a string of repeated zeros emerges. Run-length encoding reduces the amount of bits required by the variable length coding to represent these repeated zeros. The Source and Channel techniques described above apply to both image and video coding.

An additional technique that used in hybrid video codecs is motion estimation and compensation. Motion estimation and compensation removes time-related redundancies in successive video frames. This is achieved by two main approaches in motion estimation and compensation. Firstly, pixel blocks that have not changed (to within some threshold defining “change”) are considered to be the same an a motion vector is used to indicate how such a pixel block has moved between two consecutive frames. Secondly, predictive coding is used to reduce the amount of bits required by a straight DCT, quantization, zigzag, VLC encoding on a pixel block by doing this sequence of operation of the difference between the block in question and the closest matching block in the preceding frame, in addition to the motion vector required to indicate any change in position between the two blocks. This leads to a significant reduction in the amount of bits required to represent the block in question. This predictive coding approach has many variations that consider one or multiple predictive frames (process repeated a number of times, in a backward and forward manner). Eventually the errors resulting from the predictive coding can accumulate and before distortion start to be significant, an intra-coding (no predictive mode and only pixels in present frame are considered) cycle is performed on a block to encode it and to eliminate the errors accumulated so far.

According to an embodiment of the present invention, techniques to perform transcoding between two hybrid video codecs using smart techniques are provided. The intelligence in the transcoding is due to the exploitation of the similarity of the general coding principles utilized by hybrid video codecs, and the fact that a bitstream contain the encoding of video sequence can contain information that can greatly simplify the process of targeting the bitstream to another hybrid video coding standard. Tandem video transcoding by contrast decodes the incoming bitstream to YUV image representation which is a pixel representation (luminance and chrominance representation) and re-encode the pixels to the target video standard. All information in the bitstream about Source coding or Channel coding (pixel redundancies, time-related redundancies, or motion information) is unused.

According to an alternative embodiment, the present invention may reduce the computational complexity of the transcoder by exploiting the relationship between the parameters available from the decoded input bitstream and the parameters required to encode the output bitstream. The complexity may be reduced by reducing the number of computer cycles required to transcode a bitstream and/or by reducing the memory required to transcode a bitstream.

When the output codec to the transcoder supports all the features (motion vector format, frames sizes and type of spatial transform) of the input codec, the apparatus includes a VLC decoder for the incoming bitstream, a semantic mapping module and a VLC encoder for the output bitstream. The VLC decoder decodes the bitstream syntax. The semantic mapping module converts the decoded symbols of the first codec to symbols suitable for encoding in the second codec format. The syntax elements are then VLC encoded to form the output bitstream.

When the output codec to the transcoder does not support all the features (motion vector format, frames sizes and type of spatial transform) of the input codec, the apparatus the apparatus includes a decode module for the input codec, modules for converting input codec symbols to valid output codec values and an encode module for generating the output bitstream.

The present invention provides methods for converting input frames sizes to valid output codec frame sizes. One method is to make the output frame size larger than the input frame size and to fill the extra area of the output frame with a constant color. A second method is to make the output frame size smaller than the input frame size and crop the input frame to create the output frame.

The present invention provides methods for converting input motion vectors to valid output motion vectors.

If the input codec supports multiple motion vectors per macroblock and the output codec does not support the same number of motion vectors per macroblock, the number of input vectors are converted to match the available output configuration. If the output codec supports more motion vectors per macroblock than the number of input motion vectors then the input vectors are duplicated to form valid output vectors, e.g. a two motion vector per macroblock input can be converted to four motion vectors per macroblock by duplicating each of the input vectors. Conversely, if the output codec supports less motion vectors per macroblock than the input codec, the input vectors are combined to form the output vector or vectors.

If the input codec supports P frames with reference frames that are not the most recent decoded frame and the output codec does not, then the input motion vectors need to be scaled so the motion vectors now reference the most recent decoded frame.

If the resolution of motion vectors in the output codec is less than the resolution of motion vectors in the input codec then the input motion vector components are converted to the nearest valid output motion vector component value. For example, if the input codec supports quarter pixel motion compensation and the output codec only supports half pixel motion compensation, any quarter pixel motion vectors in the input are converted to the nearest half pixel values.

If the allowable range for motion vectors in the output codec is less than the allowable range of motion vectors in the input codec then the decoded or computed motion vectors are checked and, if necessary, adjusted to fall in the allowed range.

The apparatus has an optimized operation mode for macroblocks which have input motion vectors that are valid output motion vectors. This path has the additional restriction that the input and output codecs must use the same spatial transform, the same reference frames and the same quantization. In this mode, the quantized transform coefficients and their inverse transformed pixel values are routed directly from the decode part of the transcoder to the encode part, removing the need to transform, quantize, inverse quantize and inverse transform in the encode part of the transcoder.

The present invention provides methods for converting P frames to I frames. The method used is to set the output frame type to an I frame and to encode each macroblock as an intra macroblock regardless of the macroblock type in the input bitstream.

The present invention provides methods for converting “Not Coded” frames to P frames or discarding them from the transcoded bitstream.

An embodiment of the present invention is a method and apparatus for transcoding between MPEG-4 (Simple Profile) and H.263 (Baseline) video codecs.

In yet an alternative specific embodiment, the invention provides method of providing for reduced usage of reducing memory in an encoder or transcoder wherein the a range of motion vectors is provided limited to within the a predetermined neighborhood of the a macroblock being encoded. The method includes determining one or more pixels within a reference frame for motion compensation and encoding the macroblock while the range of motion vectors has been provided within the one or more pixels provided within the predetermined neighborhood of the macroblock being encoded. The method also includes storing the encoded macroblock into a buffer while the buffer maintains other encoded macroblocks.

The objects, features, and advantages of the present invention, which to the best of our knowledge are novel, are set forth with particularity in the appended claims. The present invention, both as to its organization and manner of operation, together with further objects and advantages, may best be understood by reference to the following description, taken in connection with the accompanying drawings.

### BRIEF DESCRIPTION OF THE DRAWINGS

FIG. 1 is a simplified block diagram illustrating a transcoder connection from a first hybrid video codec to a second hybrid video codec where the second codec supports features of the first codec according to an embodiment of the present invention.

FIG. 2 is a simplified block diagram illustrating a transcoder connection from H.263 to MPEG-4 according to an embodiment of the present invention.

FIG. 3 is a simplified block diagram illustrating a transcoder connection from a hybrid video codec to second hybrid video codec according to an embodiment of the present invention.

FIG. 4 is a simplified block diagram illustrating an optimized mode of a transcoder connection from a hybrid video codec to second hybrid video codec according to an embodiment of the present invention.

FIG. 5 is a simplified diagram illustrating how the reference frame and macroblock buffer are used during H.263 encoding according to an embodiment of the present invention.

### DETAILED DESCRIPTION OF THE INVENTION

According to the present invention, techniques for telecommunication are provided. More particularly, the invention provides a method and system for transcoding between hybrid video CODEC bitstreams. Merely by way of example, the invention has been applied to a telecommunication network environment, but it would be recognized that the invention has a much broader range of applicability.

A method and apparatus of the invention are discussed in detail below. In the following description, for purposes of explanation, numerous specific details are set forth in order to provide a thorough understanding of the present invention. The case of Simple Profile MPEG-4 and Baseline H.263 are used for illustration purpose and for examples. The methods described here are generic and apply to the transcoding between any pair of hybrid video codecs. A person skilled in the relevant art will recognize that other steps, configurations and arrangements can be used without departing from the spirit and scope of the present invention.

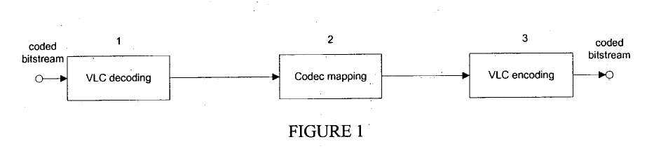

FIG. 1 is a block diagram of the preferred embodiment for transcoding between two codecs where the first codec (the input bitstream) supports a subset of the features of the second codec (the output bitstream) according to an embodiment of the present invention. This diagram is merely an example and should not unduly limit the scope of the claims herein. One of ordinary skill in the art would recognize many variations, alternatives, and modifications. The input bitstream is decoded by a variable length decoder 1. Any differences in the semantics of the decoded symbols in the first video codec and their semantics in the second video codec are resolved by the semantic conversion module 2. The coefficients are variable length coded to form the output bitstream 3. The output of stage 1 is a list of codec symbols, such as macroblock type, motion vectors and transform coefficients. The output of stage 2 is previous list with any modifications required to make the symbols conformant for the second codec. The output of stage 3 is the bitstream coded in the second codec standard.

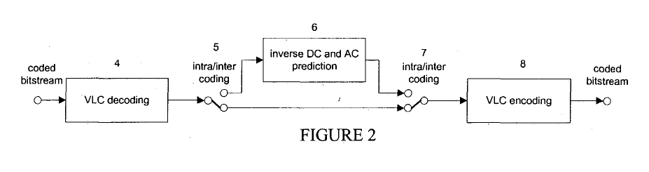

FIG. 2 is a block diagram of the preferred embodiment for transcoding a baseline H.263 bitstream to a MPEG-4 bitstream according to an embodiment of the present invention. This diagram is merely an example and should not unduly limit the scope of the claims herein. One of ordinary skill in the art would recognize many variations, alternatives, and modifications. The input bitstream is decoded by a variable length decoder 4. If the macroblock is an intra coded macroblock, the decoded coefficients are inverse intra predicted 6. Intra prediction of the DC DCT coefficient is mandatory. The transcoder may choose whether to use optional intra AC coefficient prediction. This process is the inverse of the intra prediction specified in the MPEG-4 standard. The coefficients are variable length coded to form the output bitstream 8.

When transcoding a H.263 bitstream to a MPEG-4 bitstream, the transcoder will insert MPEG-4 VisualObjectSequence, VisualObject and VideoObjectLayer headers in the output bitstream before the first transcoded video frame. The semantic conversion module 2 inserts VisualObjectSequence, VisualObject and VideoObjectLayer before the first symbol in the input list.

When transcoding a H.263 bitstream to a MPEG-4 bitstream, the picture headers in the H.263 bitstream are converted to VideoObjectPlane headers in the transcoded bitstream. The semantic conversion module 2 replaces every occurrence of “Picture header” by “VideoObjectPlane header”.

When transcoding a H.263 bitstream to a MPEG-4 bitstream, if the H.263 bitstream contains GOB headers, they are converted to video packet headers in the output bitstream. The semantic conversion module 2 replaces every occurrence of “GOB header” by “video packet header”.

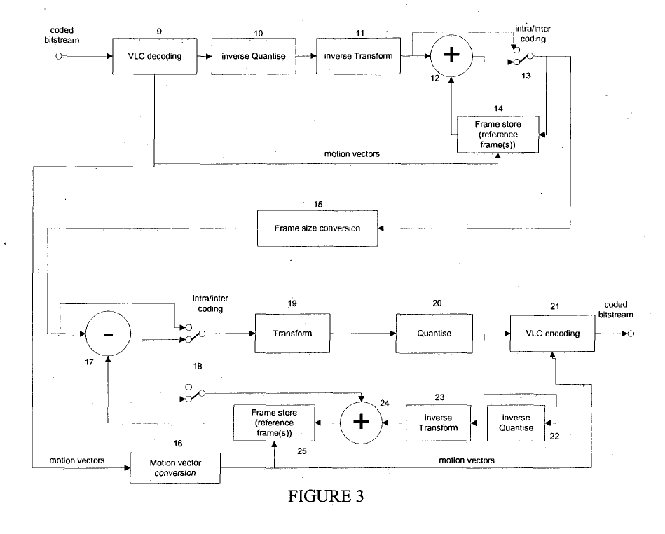

FIG. 3 is a block diagram of the preferred embodiment for transcoding between two hybrid video codecs when the output codec to the transcoder does not support the features (motion vector format, frames sizes and type of spatial transform) of the input codec according to an embodiment of the present invention. This diagram is merely an example and should not unduly limit the scope of the claims herein. One of ordinary skill in the art would recognize many variations, alternatives, and modifications. The incoming bitstream is variable length decoded 9 to produce a list of codec symbols such as macroblock type, motion vectors and transform coefficients. The transform coefficients are inverse quantised 10 and then an inverse transform 11 converts the coefficients to the pixel domain, producing a decoded image for the current macroblock. For inter coded macroblock, this image is added 12 to the motion compensated macroblock image recovered from the reference frame 14. This comprises a standard decoder for the input hybrid video codec.

Some output video codec standards allows the decoder to support only a subset of the frame sizes supported by the input codec. If the input frame size is not supported by output codec, the transcoder outputs the largest legal output frame that entirely contains the input frame and performs frame size conversion 15. The output frame is centered on the input frame. If the input frame is an I frame, the areas of the output frame that are outside the input frame are coded as a suitable background color. If the input frame is a P frame, areas of the output frame that are outside the input frame are coded as not coded macroblocks.

An alternative method to achieve frame size conversion is for the transcoder to output the largest legal output frame size that fits entirely within the input frame. The output frame is centered in the input frame. In this case, the frame size conversion module 15 will crop the input frame, discarding any input macroblocks that fall outside the output frame boundaries.

There are four features of motion vectors that may be supported by the input codec but not supported by output codec. They are differences in the number of motion vectors per macroblock, differences in the reference frame used for the motion compensation, differences in the resolutions of the motion vector components, differences in the allowed range of the motion vectors. In each case, the motion vector conversion unit 16 of the transcoder must choose a valid output motion vector that “best approximates” the input motion information. These conversions may result in either loss of image quality and/or an increase in the outgoing bitstream size.

When the input motion vector(s) is different from the output motion vector(s), it is necessary to re-compute the macroblock error coefficients during the encode stage using the encoder reference frame 25.

If the input codec supports multiple motion vectors per macroblock and the output codec does not support the same number of motion vectors per macroblock, the number of input vectors are converted to match the available output configuration. If the output codec supports more motion vectors per macroblock than the number of input motion vectors then the input vectors are duplicated to form valid output vectors, e.g. a two motion vector per macroblock input can be converted to four motion vectors per macroblock by duplicating each of the input vectors. Conversely, if the output codec supports less motion vectors per macroblock than the input codec, the input vectors are combined to form the output vector or vectors. For example, when a MPEG-4 to H.263 transcoder encounters an input macroblock with 4 motion vectors, it must combine the 4 vectors to obtain a single output motion vector.

One method for combining motion vectors is to use the means of the x and y components of the input vectors.

Another method is to take the medians of the x and y components of the input vectors.

The conversion from multiple input motion vectors to a required number of output motion vectors is always performed first and the resulting vector(s) are used as the input for the following conversions if they are required.

If the input codec supports P frames with reference frames that are not the most recent decoded frame and the output codec does not, then the input motion vectors need to be scaled so the motion vectors now reference the most recent decoded frame. The scaling is performed by dividing each component of the input vector by the number of skipped reference frames plus one.

If the resolution of motion vectors in the output codec is less than the resolution of motion vectors in the input codec then the input motion vector components are converted to the nearest valid output motion vector component value. For example, if the input codec supports quarter pixel motion compensation and the output codec only supports half pixel motion compensation, any quarter pixel motion vectors in the input are converted to the nearest half pixel values.

When the transcoder encounters input motion vectors with one or both components outside the range allowed for the output codec it must convert the vector to an allowed output value. A similar situation arises when the input motion vectors can point to areas outside the video frame boundary and the output motion vectors are restricted to pointing within the image. In both cases the algorithm selects a valid output vector based on the input vector.

One method of conversion is to clamp the output motion vector component to the closest allowable value. For example, MPEG-4 motion vectors can be larger than the H.263 range of −16 to 15.5 pixels. In this case the x component of the computed H.263 vector, μ, is given by

$${u}^{x} = \{ \begin{matrix}- 16 & {v}^{x} < - 16 \\ {v}^{x} & - 16 \leq {v}^{x} < 16. \\ 15.5 & {v}^{x} \geq 16\end{matrix}$$

A second method of conversion is to make the output vector the largest valid output vector with the same direction as the input vector.

After frame size and motion vector conversion, the decoded macroblock pixels are spatially transformed 19, after having the motion compensated reference values 25 subtracted 17 for inter macroblocks. The transform coefficients are quantised 20 and variable length encoded 21 before being transmitted. The quantised transform coefficients are inverse quantised 22 and converted to the pixel domain by an inverse transform 23. For intra macroblocks, the pixels are stored directly in the reference frame store 25. Inter macroblocks are added 24 to the motion compensated reference pixels before being stored in the reference frame store 25.

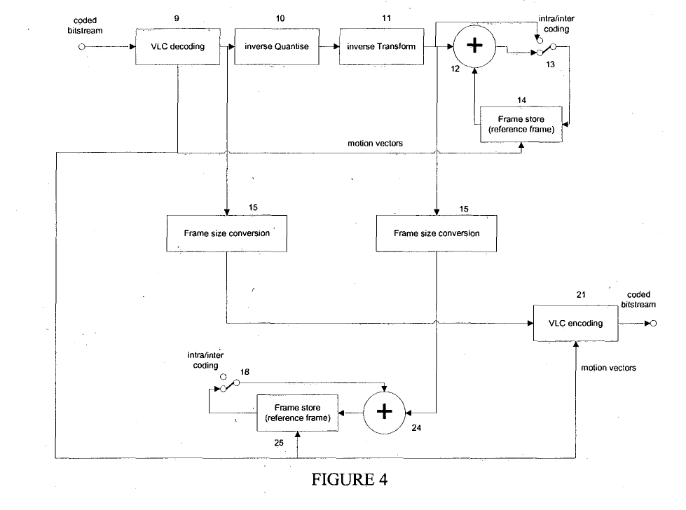

FIG. 4 is a block diagram of an optimized mode of the preferred embodiment for transcoding between two hybrid video codecs when the output codec to the transcoder does not support the features (motion vector format, frames sizes and type of spatial transform) of the input codec according to an embodiment of the present invention. This diagram is merely an example and should not unduly limit the scope of the claims herein. One of ordinary skill in the art would recognize many variations, alternatives, and modifications. The optimized mode is only available when the input and output codecs use the same spatial transform, the same reference frames and the same quantization. The optimized mode is used for inter macroblocks which have input motion vectors that are legal output motion vectors. In the optimized mode, the output of the inverse quantizer 10 and the inverse spatial transform 11 are, after frame size conversion, fed directly to the variable length encoder 21 and the frame store update 24 respectively. This mode is significantly more efficient because it does not use the encode side spatial transform 19, quantizer 20, inverse quantizer 22 and inverse transform 23 modules. If the decoder motion compensation 12 and encoder motion compensation 24 employ different rounding conventions is necessary to periodically run each frame through the full transcode path shown in FIG. 3 to ensure that there is no visible drift between the output of the original bitstream and the transcoder output.

The H.263 standard specifies that each macroblock must be intra coded at least once every 132 frames. There is no similar requirement in the MPEG-4 standard. In our method, to ensure that each macroblock satisfies the H.263 intra coding constraint, the transcoder tracks the number of frames since the last MPEG-4 I frame and, if there are more than 131 P frames in the MPEG-4 stream since the last I frame, forcibly encodes the decoded P frame as an I frame.

If the input codec supports “Not Coded” frames and the output codec does not the apparatus will convert the frame. One method of conversion is for the transcoder to entirely drop the frame from the transcoded bitstream. A second method of conversion is for the transcoder to transmit the frame as a P frame with all macroblocks coded as “not coded” macroblocks.

The reference frame stores 14, 25 are normally implemented as two separate frames in conventional decoders and encoders. One is the reference frame (the previous encoded frame) and one is the current encoded frame. When the codec motion vectors are only allowed to take a restricted range of values it is possible to reduce these storage requirements. In our method, we reduce the storage requirements substantially by recognizing that the only reference frame macroblocks that are used when a macroblock is encoded are its neighbors within the range of the maximum allowed motion vector values.

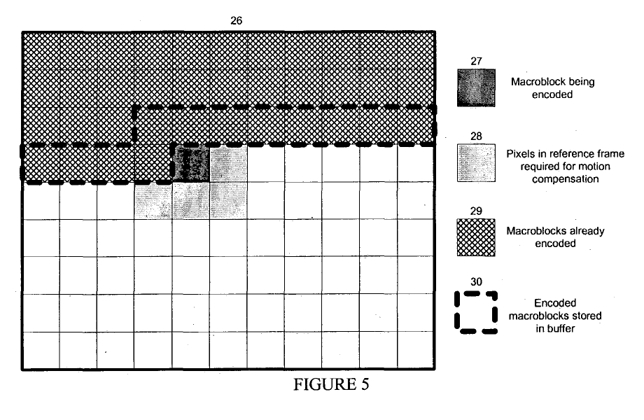

FIG. 5 illustrates the macroblock buffering procedure using a QCIF sized frame 26 with its underlying 9 by 11 grid of macroblocks being encoded in baseline H.263 as an example. This diagram is merely an example and should not unduly limit the scope of the claims herein. One of ordinary skill in the art would recognize many variations, alternatives, and modifications. The macroblocks immediately surrounding 28 the macroblock currently being encoded 27 contain pixels in the reference frame that may be used for motion compensation during the encoding. The macroblocks preceding the macroblock being coded 27 have already been encoded 29. The maximum range of baseline H.263 motion vectors of −16 to 15.5 pixels. Instead of storing the current image, we maintain a macroblock buffer 30 that can hold the number of macroblocks in an image row plus 1. After each macroblock is coded, the oldest macroblock in the buffer is written to its location in the reference image and the current macroblock is written in to the buffer.

The buffer can also store whether or not each macroblock in the buffer is coded or “not coded”. In the case of “not coded” macroblocks, our method will skip writing these macroblocks into the buffer and writing them back out to the reference frame as the macroblock pixel values are unchanged from those in the reference frame.

The previous description of the preferred embodiment is provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

What is claimed is:

1. An apparatus for processing a video bitstream coded from a first hybrid video codec to a bitstream coded for a second hybrid video codec, the apparatus comprising;
a variable length decoder to decode the incoming video bitstream from the first hybrid video codec, the variable length decoder being adapted to output a decoded bitstream
a unit to perform semantic conversion of the decoded symbols, the semantic conversion processing a portion of the decoded bitstream to adapt the decoded bitstream to be compatible with the second hybrid video codec; and
a variable length encoder to encode the outgoing bitstream from the output of the unit to the second hybrid video codec.

2. The apparatus of claim 1 wherein the first video codec is baseline H.263 and the second video codec is MPEG-4 and wherein the semantic conversion in the unit comprise an inverse intra AC prediction of a plurality of intra macroblock coefficients based upon one or more predetermined parameters.

3. The apparatus of claim 2 wherein the one or more predetermined parameters to perform the intra AC prediction is provided on a macroblock by macroblock basis and a processing is provided on the macroblock by macroblock basis.

4. An apparatus for processing a video bitstream coded from a first hybrid video codec to a bitstream coded to a second hybrid video codec comprising:
decoding of the input bitstream comprising a plurality of macroblocks from the first hybrid codec on a macroblock by macroblock basis among the plurality of macroblocks,
determining if an input frame size of the plurality of macroblocks is supported by the second hybrid codec;
converting the input frame size to be supported by the second hybrid codec if the input frame size is not supported by the second hybrid codec;
determining if one or more of a plurality of input motion vectors is supported by the second hybrid codec;
converting the one or more input motion vectors to be supported by the second hybrid codec if the one or more input motion vectors is not supported by the second hybrid codecs to form resulting transcoded data; and
encoding of the transcoded data of the plurality of macroblocks on a macroblock by macroblock basis.

5. The apparatus of claim 4 wherein the first video codec is Simple Profile MPEG 4 and the second video codec is Baseline H.263.

6. The apparatus of claim 4 wherein the input video frames that are not a valid output frame size are converted by setting the output frame size to the smallest valid output frame size that is larger than the input frame size and;
for intra frames, encoding the additional macroblocks in the output frame as a fixed value,
for inter frames, encoding the additional macroblocks in the output frame as “not coded” macroblock.

7. The apparatus of claim 4 wherein the input video frames that are not a valid output frame size are converted by setting the output frame size to the largest valid output frame size that is smaller than the input frame size and cropping macroblocks from the input frame that do not fit in the output frame.

8. The apparatus of claim 4 wherein the input macroblocks with multiple motion vectors are converted to a larger number of output motion vectors by replicating the motion vectors.

9. The apparatus of claim 4 wherein the input macroblocks with multiple motion vectors are converted to a smaller number of output motion vectors by one or more processes including an arithmetic mean or a median process.

10. The apparatus of claim 4 wherein the input motion vectors that reference a different reference frame than the output codec reference frame are scaled to form the output motion vectors.

11. The apparatus of claim 4 wherein the input motion vectors that use a higher resolution than that supported by the output codec are rounded to the nearest valid output motion vector.

12. The apparatus of claim 4 wherein the input motion vectors that are outside the range of valid output motion vectors are converted by clipping the components to the largest allowed output values.

13. The apparatus of claim 4 wherein the input motion vectors that are outside the range of valid output motion vectors are converted by choosing the largest valid output vector with the same direction as the input vector.

14. The apparatus of claim 4 wherein the determining, converting, determining, and converting are provided by computer codes.

15. The apparatus of claim 9 wherein MPEG-4 macroblocks with 4 motion vectors are converted to a single motion vector by averaging the 4 vectors by one or more processes including an arithmetic mean or a median process.

16. The apparatus of claim 12 wherein the MPEG-4 motion vectors that are outside the range of valid H.263 motion vectors are converted by clipping the components to the largest allowed H.263 values.

17. The apparatus of claim 13 wherein the MPEG-4 motion vectors that are outside the range of valid H.263 motion vectors are converted by choosing the largest valid H.263 vector with the same direction as the MPEG-4 vector.

18. The apparatus of claim 12 wherein the MPEG-4 motion vectors that point outside the video frame are converted by clipping the components of the vectors to the frame edge.

19. The apparatus in claim 4 wherein the first hybrid codec and the second hybrid codec have a same spatial transform, same reference frames and quantization, same inter macroblocks with input motion vectors that are valid output motion vectors are transcoded by a method comprising;
decoding of an input bitstream macroblock;
determining if an input frame size of the plurality of macroblocks is supported by the second hybrid codec;
converting the input frame size to be supported by the second hybrid codec if the input frame size is not supported by the second hybrid codec;
performing a VLC encoding process one one or more of a plurality of quantized transform coefficients from the decoded input bitstream macroblock,
using one or more of the macroblock pixel values from the decoded input bitstream macroblock to update an encoder reference frame.

20. The apparatus of claim 19 further comprising skipping at a predetermined frequency an optimized mode to prevent build up of a drift in a transcoding process of at least determining, converting, and performing.

21. The apparatus of claim 19 wherein the first video codec is Simple Profile MPEG 4 and the second video codec is Baseline H.263.

22. The apparatus of claim 4 wherein the unit is further adapted to convert the selected input P frames into I frames.

23. The apparatus of claim 4 further comprising removing MPEG-4 “Not Coded” frames from the decoded bitstream.

24. The apparatus of claim 4 further comprising converting one or more of MPEG-4 “Not Coded” frames into an H.263 P frame with each macroblock coded as a “not coded” macroblock.

25. A method of providing for reduced usage of memory in an encoder or transcoder wherein a range of motion vectors is provided within a predetermined neighborhood of a macroblock being encoded, the method comprising:
determining one or more pixels within a reference frame for motion compensation;
encoding the macroblock while the range of motion vectors has been provided within the one or more pixels provided within the predetermined neighborhood of the macroblock being encoded; and
storing the encoded macroblock into a buffer while the buffer maintains other encoded macroblocks.

26. The method of claim 25 wherein the buffer is free from any macroblocks that are not coded.

27. The method of claim 25 wherein the encoder or transcoder is for a baseline H.263 encoder or transcoder, the method comprising;
storing, for a single reference frame, and for a buffer, a number of macroblocks indicative of one frame row plus one macroblock;
writing an oldest macroblock in the buffer to a reference frame; and
replacing the oldest macroblock in the buffer with an encoded macroblock.
